(19) United States
(12) Patent Application Publication
(10) Pub. No.: US 2006/0043625 A1
(43) Pub. Date: Mar. 2, 2006

(54) Laminating process

(76) Inventor: George S. Medynski, Hohokus, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/928,287

(22) Filed: Aug. 27, 2004

(51) Int. Cl. B29C 44/12; E04F 13/00

(52) U.S. Cl. 264/46.4; 156/71; 264/321; 264/324; 264/162

(57) ABSTRACT

A process for altering the shape of a motor vehicle. The process includes depositing a foam base on the motor vehicle. The foam base is sculpted and/or sanded to a desired shape to create a structure. A fiberglass resin and cloth are applied to the structure.

### BACKGROUND OF THE INVENTION

The present invention relates generally to a laminating process and more specifically to a laminating process for altering the shape of a base object. Although the base object may comprise many shapes and structures, the present invention is particularly adapted for altering and modifying the exterior of a motor vehicle.

Many applications involve shaping of a base object to a desired form. For example, car enthusiasts spend a significant amount of time shaping and redesigning a motor vehicle's exterior features. Be it aerodynamic features such as spoilers and the like, designed to increase the speed of a car or just simply aesthetically pleasing features, many man hours are spent crafting, welding or redesigning various parts of a motor vehicle as well as other structures.

Car reshaping has become such a large business that television shows, such as MTV's Pimp My Ride, documenting this phenomenon have found an increasingly large audience. Cult heroes and infamous icons previously only known to those in this niche community have gained tremendous popularity with the masses. Unfortunately, until now, a person seeking to reshape a motor vehicle would have to contact a person within this niche community. This is so because both experience and talent are required for remodeling a vehicle's structure, in addition to access to large and expensive machinery. This often leads the amateur enthusiast to seek out professional craftsmen to modify their vehicle to a desired shape.

Of course the more renowned and accomplished craftsmen may charge higher prices for the alteration of a vehicle's body structure. Additionally, the high demand for these craftsmen limits their availability to modify a motor vehicle. Therefore, there might not be qualified craftsmen in one's area, or the few craftsmen in a particular area might be significantly backlogged and unable to start work on a customer's vehicle in a timely manner. Another downside of existing body modification techniques is that delays in obtaining particular parts and assemblies may cause a vehicle to be in the shop longer than expected.

A professional auto body mechanic generally redesigns the structure of a vehicle by welding and cutting the original structure. This enables the professional auto body mechanic to redesign the structure of a vehicle to such an extent that the original shape is unrecognizable. However, once the restructuring has been finished, it is virtually impossible to undo the restructuring to return the vehicle to its original condition. To do so would require substantial effort and expense.

Further, with present technology, slight alterations and modifications to a feature that has been added to a vehicle, such as a spoiler, may not be possible without replacement of the entire spoiler. This significantly increases the cost of modification of an added feature.

After a vehicle has been damaged in an accident, often the only way to repair a damaged body part is to replace it with a new part. This has become increasingly cost-prohibitive, especially considering that many accidents involve more than one vehicle partition panel located on the exterior structure of a motor vehicle. Newer motor vehicle parts generally have less structural integrity than older vehicles, and a minor collision in a newer vehicle often has catastrophic consequences to at least the car's exterior structure, increasing the cost of repairs. A need exists to provide a less expensive and more efficient way to modify damaged vehicle parts and to make alterations to vehicle bodies.

### SUMMARY OF THE INVENTION

The present invention relates to a process for altering the shape of a motor vehicle. The process preferably includes depositing a foam base on the motor vehicle. The foam base is then sculpted or sanded to a desired shape to create a structure. A fiberglass resin and fiberglass cloth is then applied to the structure. In one preferred embodiment the motor vehicle is a car. The foam mass may be deposited on the exterior of the car.

The process may further include sanding the fiberglass resin and applying at least one layer of a VOC compliant 2-part polyester base filler/glazing compound so as to coat the fiberglass resin. The filler/glazing compound once applied to the structure may then be sanded. Additionally, a polyethylene-homopolymer primer may be applied to the structure. The primer may also be sanded once applied to the foam base.

The foam base may include a polymer C isocyanate and a polyurethane resin. The process may be repeated numerous times until reaching the desired shape and/or structure.

In an additional embodiment of the present invention, the process may include providing a mold having an interior surface at least partially defining a void. Next, a thin film is applied to the interior surface of the mold. A fiberglass resin and/or fiberglass cloth may then be applied to the thin film. The remaining void being at least partially filled with a foam to form a structure. Once cured the structure may be removed from the mold and attached to a motor vehicle. Prior to removing the structure from the mold, the structure may be sanded, cut, reshaped or the like. An additional layer of a fiberglass resin and fiberglass cloth may be applied to the structure not in contact with the thin film. The structure may be lightly sanded and sprayed with a fiberglass resin with a VOC-compliant 2-part polyester base filler/glazing compound on the resin. A polyethylene-homopolymer primer may then be sprayed on the VOC-compound. The structure may then be painted and/or finished.

### BRIEF DESCRIPTION OF THE DRAWINGS

FIG. 1 shows an unmodified object;

FIG. 2 illustrates a foam mass being applied to a base object;

FIG. 3 illustrates an exemplary structure that may be formed result the foam mass of FIG. 2;

FIG. 4 is a cross-sectional view of a portion of the sculpted structure with a fiberglass resin and fiberglass cloth applied thereto;

FIG. 5 illustrates an alternate embodiment of the present invention;

FIG. 6 illustrates another alternate embodiment of the present invention;

FIG. 7 illustrates a cross-sectional view of an alternate embodiment of the present invention;

FIG. 8 illustrates an additional alternate embodiment of the present invention;

FIG. 9 illustrates an embodiment of the present invention being used to connect two discrete elements;

FIG. 10 respectively illustrates a standard vehicle; and

FIG. 11 illustrates the vehicle of FIG. 10 contoured to look like a different vehicle.

### DETAILED DESCRIPTION

Referring to FIG. 1, one or more embodiments of the present invention may involve modification of a base object 10 having a predetermined shape. Although the shape is shown as being rectangular, the base object may be any geometric shape. In a certain embodiment, the base object may be a motor vehicle or a portion of a motor vehicle such as a trunk of a car. Additional base objects may include boats, furniture, non-motor vehicles and the like. The base object 10 includes an exterior surface 12 at least partially defining the base object.

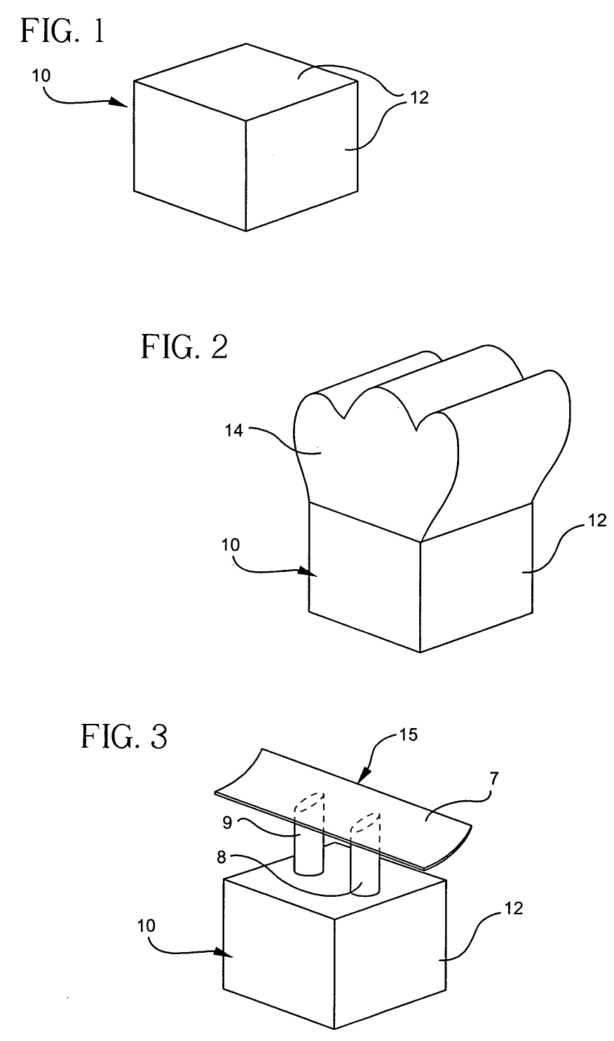

Referring now to FIG. 2, to alter the exterior shape of the base object 10, a laminating process may be performed, by applying a foam mass 14 to exterior surface 12 of the base object 10. The foam mass may be sprayed from a dispenser or otherwise directly applied to exterior surface 12 of base object 10 and permitted to assume any configuration. Although foam mass 14 is shown being disposed on an upper surface of the base object 10, due to its adhesion properties, foam mass 14 may be disposed on any surface of base object 10. In one embodiment, the foam mass 14 comprises a polymeric isocyanate and a polyurethane resin. This combination of materials provides adhesion to objects and quick set-up time. It is generally desirable that the foam sets up in three to ten minutes under normal atmospheric conditions. Additionally, it is desirable for the foam to be dense enough so that during a sanding process, the dust falls downward rather than remain airborne for a significant time. This reduces inhalation of dust particles.

During application, upon being dispensed from a canister or other dispenser, foam mass 14 generally will expand to encompass a greater area than that originally dispensed. This is similar to dispensing shaving gel from a canister and letting it expand. According to one embodiment, the size of foam mass 14 applied to the object is at least equal to or greater than the size of the feature to be added to base object 10. Thus, the basic structure of the final desired shape and size should be considered prior to dispensing foam mass 14 onto base object 10. Additional foam mass 14 may be added at any time during the laminating process to increase the size of the final product.

After foam mass 14 has cured, the mass may be sculpted and contoured to the desired shape. Various tools may be employed for this task, for example, sanders, knives and saws or the like. Although any shape may be produced, the spoiler 15, shown in FIG. 3, will be used to illustrate the laminating process. It will be understood that various other shapes can be provided according to the present invention including, but not limited to, fins, tails, incline ramps, scoops, simulated air vents and the like.

Spoiler 15 can be formed by cutting and sanding foam mass 14. As previously mentioned, foam mass 14 may comprise additional amounts of foam applied to the original mass. A subsequent sculpting step may be used to obtain the desired shape. Spoiler 15 may be created in a single cutting stage with main body 7 and supports 8 and 9 being carved and shaped from the same foam mass 14. Alternatively, spoiler 15 may be created from three separate and discrete foam masses which can be attached afterwards as will later be described.

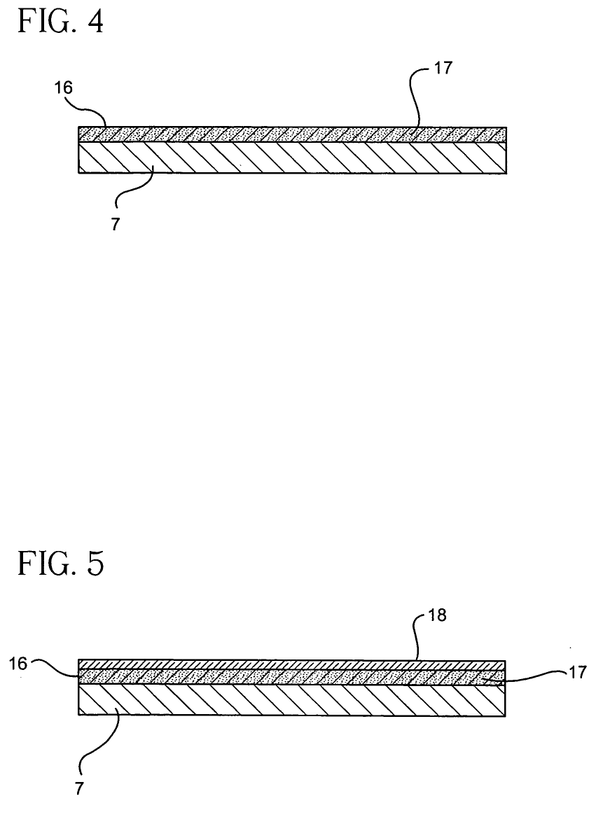

The final spoiler 15 may have an uneven exterior texture due to the foam having a porous structure. Therefore, even after sanding the surface of spoiler 15, the surface may not be as smooth as desired. To achieve a more finished appearance, various additional processing steps may be carried out, such as application of a subsequent coat of fiberglass resin 16. As shown in FIG. 4, fiberglass resin 16 coats spoiler 15 and preferably adheres to the entire surface area of the spoiler. For ease of illustration, FIG. 4 details only a partial portion of spoiler 15, specifically, a cross-section of main body 7 of spoiler 15. Fiberglass resin 16 may then be contacted with fiberglass cloth 17, which acts as a catalyst for fiberglass resin 16. Once resin 16 is contacted with cloth 17, the resin begins to harden and confers a smooth texture to spoiler 15.

In an alternate approach, resin 16 and cloth 17, rather than being separately applied to spoiler 15 as described above, may be combined and then applied to spoiler 15. According to this embodiment, cloth 17 may be chopped up and mixed with resin 16. The two elements may then be applied to spoiler 15. After application of the resin 16, any imperfections and rough spots may be sanded and removed. A coat of paint or another finish product may also be applied to spoiler 15.

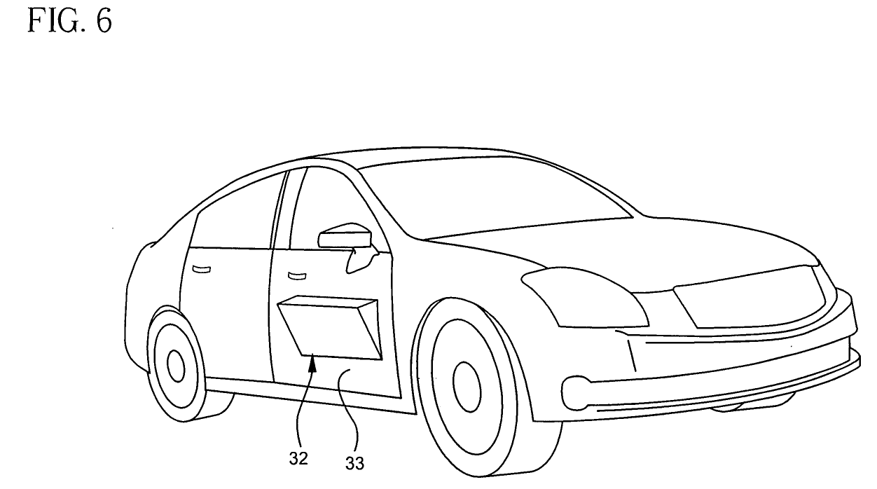

In an alternate embodiment, prior to painting spoiler 15, a coat of filler/glazing compound 18 may be sprayed onto foam mass 14 and fiberglass resin 16, for example, a VOC-compliant 2-coat polyester base. FIG. 5 shows a glazing compound 18 applied on a fiberglass resin. Compound 18 desirably has a rapid curing time. Additionally, compound 18 should have a high build capability, preferably of between about 15-30 mils for each individual layer. Additional layers of compound 18 may be applied as required. Compound 18 preferably eliminates any remaining imperfections on the surface of spoiler 15, leaving a smooth and finished surface.

One or more embodiments of the invention provide virtually unlimited possibilities for modifying cars, motorcycles, boats, bicycles, or any other base object. The foam and additional layers may increase the function and/or structural integrity of the object to which they are applied. For instance, if a feature such as incline ramp 32, shown in FIG. 6, were to be molded and shaped onto car door 33, various aerodynamic advantages can be realized. Further, incline ramp feature 32 may prevent damage to the door. This is because the ramp comprised of layers will not only act as a buffer and absorb at least some of the force, but will also disperse the point of contact over a larger surface area thereby reducing the force at a specific point on the door.

One or more embodiments of the present invention produce light-weight elements that can be easily handled and manipulated by a single individual. This reduces the manpower and the cost required to create and modify objects such as motor vehicles. Further, since the finished product is mainly comprised of foam, the actual individual element may increase the buoyancy of the base object to which it is attached.

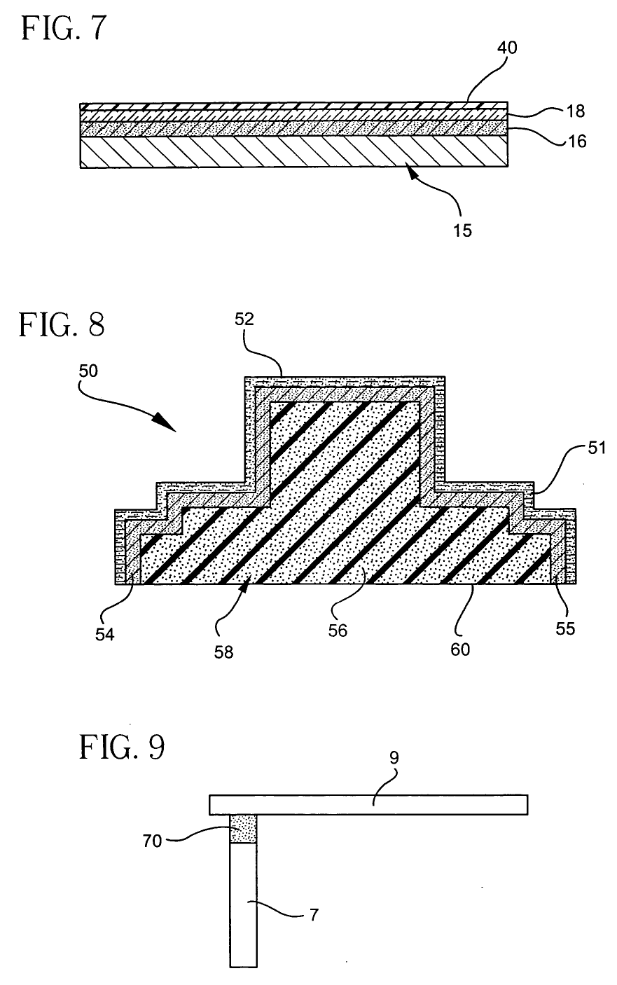

In an alternate embodiment of the present invention, after applying compound 18 to spoiler 15 and prior to a finishing layer of paint or the like be applied to the spoiler, a layer of polyethylene-homopolymer primer 40 may be applied as a top coat. FIG. 7 shows a structure including such a layer 40. Application of primer 40 will depend on the desired texture or finish. As previously stated, a finishing coat of paint or the like may be applied after primer 40.

In another alternate embodiment, the process, which has been described herein, may be substantially performed in reverse. As shown in FIG. 8, mold 50 may be provided in any continuous shape. A layer of thin film gel 51 is applied to interior surface 52 of mold 50. Gel coat 51 enables the molded product to be removed from mold 50 once it has cured, without incurring substantial damage. It will be understood that thin film gel coat 51 may be replaced by any element that would provide the same effect.

Resin 54 with cloth 55, as earlier described, may be applied to the gel coat either simultaneously or separately. Although the layers of gel and such are shown as being applied with a constant thickness, this configuration is not required. Foam 56 may then be applied to resin 54 to act as a stable support and provide structural integrity to the finished product as well as provide a three-dimensional effect desired for the final product. Foam 56 may completely fill the remaining void of mold 50 as shown in FIG. 8 or, alternately, may only partially fill the void.

Once the foam mold 58 has been allowed to set, it may gently be removed from mold 50 as assisted by the gel. Similar techniques, as described above, such as applying compound 18 and primer 40 as well as sanding, sculpting and shaping the foam mass, may then be carried out to obtain a finished product.

Either prior to or after removing the foam mold 58 from mold 50, the non-coated surface area 60 of foam 56 may also be coated with resin 54 and exposed to cloth 55 as earlier described. This enables foam mold 58 to have a consistent textured outer surface. Of course, foam mold 58, specifically surface area 60, may be sculpted and shaped prior to any resin application. Additional layering and sanding steps, as described herein, may be utilized to achieve a finished product. Foam mold 58 is now a complete and finished product and may be mounted to a base object using techniques described herein or those known in the art.

A benefit of this process is that it may be used to first create the desired element as already described above. Next, the process may be used to create the mold that can be employed to create substantially similar copies of the original, such as entire car panels and doors may be created using this process.

Of course, two different elements may be created individually and then later joined together either by the process described herein, or an alternative method. In this instance, an intermediate foam product, i.e., connecting foam mass 70, may be used to attach two distinct elements. As shown in FIG. 9, main body 7 and support 9 included with the earlier described spoiler 15, may be attached using this technique. The connecting foam mass 70 may be dispensed on element 7 and then attached to element 9. Due to the adhesion properties of foam mass 70, once it is allowed to cure, elements 7 and 9 are adhered together. Connecting foam mass 70 may now be shaped and sanded in order to achieve a desired shape. Further, the remaining steps of the laminating process, previously described, may be preformed on connecting foam mass 70 to achieve a uniform and finished product.

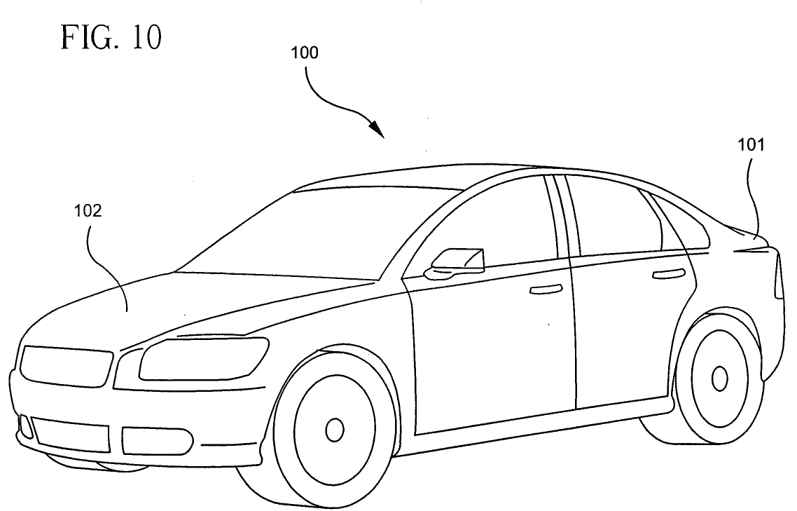

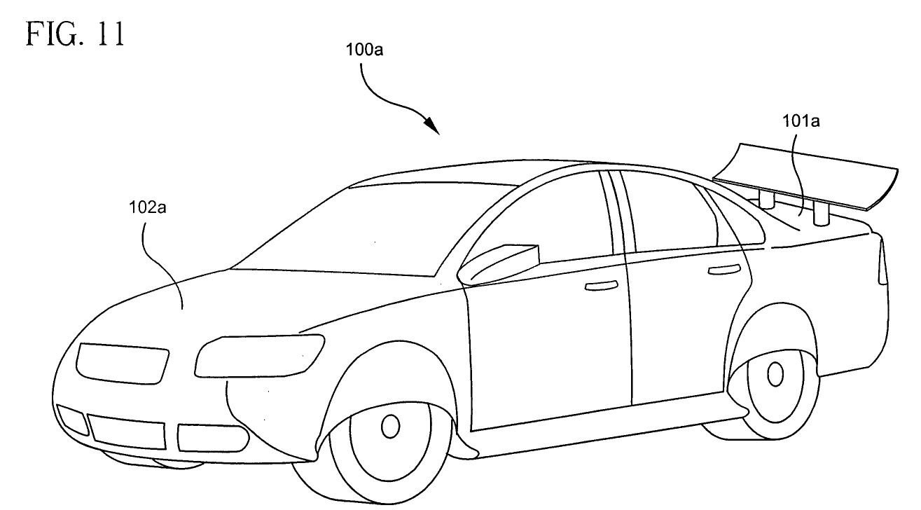

FIGS. 10 and 11 illustrate an alteration of a motor vehicle. FIG. 10 shows a possible base object, for example, car 100. Car 100 is an ordinary standard car having a trunk 101 and hood 102. Utilizing techniques described herein, the finished product, car 101a, may look similar to the original car with new features as shown in FIG. 11. The car may also look like an entirely different car. The resulting car may be modified to resemble an SUV or any other type of vehicle.

Although reference has been made to motor vehicles throughout the specification, the present application is not limited thereto. The present invention can be adapted for use for modifying any base object in which the foam mass may adhered to. For instance, the present invention may be used to alter the shape of motorcycle helmets, skateboards, bicycles, boats be it the keel or a portion of the deck, just to name a few non-limiting possibilities.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A process for altering the shape of a motor vehicle, the process comprising:
depositing a foam base on the motor vehicle;
sculpting and/or sanding said foam base to a desired shape to create a structure; and
applying a fiberglass resin and fiberglass cloth to said structure.

2. The process according to claim 1, wherein the motor vehicle is a car.

3. The process according to claim 2, wherein said foam mass is deposited on an exterior of said car.

4. The process according to claim 1, further comprising sanding said fiberglass resin and applying at least one layer of a VOC-compliant 2-part polyester base filler/glazing compound so as to coat said fiberglass resin.

5. The process according to claim 4, further comprising sanding said filler/glazing compound.

6. The process according to claim 4, further comprising sanding said base filler/glazing compound and then applying a polyethylene-homopolymer primer to said structure.

7. The process according to claim 6, further comprising sanding said foam base after said primer is applied to said foam base.

8. The process according to claim 1, wherein said foam base includes a polymer C isocyanate and polyurethane resin.

9. The process according to claim 1, further comprising repeating the steps of claim 1.

10. A process for creating a structure, the process comprising:
providing a mold having an interior surface at least partially defining a void;
applying a thin film to said interior surface of said mold;
applying a fiberglass resin and fiberglass cloth to said thin film; and
at least partially filing said remaining void with a foam to form a structure;
removing said structure from said mold; and
attaching said structure to a motor vehicle.

11. The process according to claim 10, wherein said foam includes a polymer C isocyanate and polyurethane resin.

12. The process according to claim 10, further comprising sanding, cutting or reshaping said foam in said mold.

13. The process according to claim 10, further comprising allowing said foam, said fiberglass resin and fiberglass cloth to cure so as to result in a structure, removing said structure from said mold, applying a fiberglass resin and fiberglass cloth to a side of the structure not in contact with said thin film.

14. The process according to claim 13, further comprising lightly sanding said fiberglass resin and spraying said fiberglass resin with a VOC-compliant 2-part polyester base filler/glazing compound to said resin.

15. The process according to claim 14, further comprising spraying said VOC-compound with a polyethylene-homopolymer primer.

16. The process according to claim 13, further comprising painting or finishing said structure.
